(19) United States
(12) Patent Application Publication
(10) Pub. No.: US 2026/0052153 A1
(43) Pub. Date: Feb. 19, 2026

(54) ENABLING FINE-GRANULAR ROLE-BASED ACCESS CONTROL IN ENTERPRISE NETWORKS

(71) Applicant: Cisco Technology, Inc., San Jose, CA (US)

(72) Inventors: Ramesh Nethi, Bangalore (IN); Prashanth Patil, San Jose, CA (US); Elango Ganesan, San Jose, CA (US)

(21) Appl. No.: 18/807,474

(22) Filed: Aug. 16, 2024

(51) Int. Cl. H04L 9/40

(52) U.S. Cl. CPC H04L 63/104; H04L 63/0807; H04L 63/105

(57) ABSTRACT

The techniques described herein enable fine-granular role-based access controls for retrieval augmented generation based large language models in enterprise systems. Existing techniques for implementing LLMs in network controller and network management software do not offer differentiated access to data input to the LLM, resulting in the users of the LLM receiving the same results, including results the user may not be authorized to access. This introduces security risks to the enterprise network. The techniques described herein provide mechanisms that remove the security risks and ensure that an LLM receives context data that is filtered and tailored based on the level of access the user has within the enterprise network.

### TECHNICAL FIELD

The present disclosure relates generally to the field of field of enterprise networking, and more particularly to enabling fine-granular RBAC for RAG applications in network controllers.

### BACKGROUND

In enterprise environments, network controllers play a crucial role in managing the security posture of network devices and applications. Large Language Models (LLMs) may be utilized in enterprise software such as network controllers and network management software. LLMs are generally trained using public data sets, such as foundational models. RAG (Retrieval Augmented Generation) is an architectural pattern that enables private data (e.g., such as domain specific data) to be leveraged by an LLM for variety of tasks such as summarization, extraction, reasoning, transformation, automation etc. For instance, with the introduction of transformer based LLMs, RAG has become an architectural pattern that is utilized to bring the power of GenAI to custom (e.g., personal, public, and enterprise) data, that is not part of foundational model's training dataset.

In enterprise networks, role-based access controls (RBACs) in network controllers and network management software may supports typical RBACs, but also may extend RBACs to fine-granular network constructs such as Network Devices, Sites, Fabric, arbitrary groups of devices, etc. In standard NIST RBAC models, users may be assigned to one or more roles and roles depict a set of allowed permissions (permission set), where each permission represents RBAC resource type (to which access control is applied) and a set of allowed operations on that resource type. Thus, having a fine-granular RBAC over the network data and policies may be important for maintaining security within the enterprise network.

In some cases, network controllers and network management software of an enterprise network may leverage RAG in order to integrate using LLMs with dynamic and static network data, inventory, configuration, policies etc. However, RAG enabled LLMs currently do not consider RBACs when retrieving vector embeddings or generating outputs to a user's query, resulting in security risks to the network.

Accordingly, there is a need for a mechanism to enable fine-granular RBAC for RAG applications in network controllers that minimize security risks and improve accuracy of responses in enterprise networks.

### BRIEF DESCRIPTION OF THE DRAWINGS

The detailed description is set forth below with reference to the accompanying figures. In the figures, the left-most digit(s) of a reference number identifies the figure in which the reference number first appears. The use of the same reference numbers in different figures indicates similar or identical items. The systems depicted in the accompanying figures are not to scale and components within the figures may be depicted not to scale with each other.

FIG. 1 illustrates a system-architecture diagram of an environment in which a system can enable fine-granular RBAC in RAG applications of a network controller.

FIG. 2 illustrates a component diagram of an example network controller described in FIG. 1.

FIG. 3 illustrates an example embodiment of fine-granular RBACs within an enterprise system, according to the techniques of FIGS. 1 and 2.

FIG. 4 illustrates an exemplary embodiment of an architecture that may implement the fine-granular RBAC into RAG applications of a network controller in an enterprise system, according to the techniques of FIGS. 1-3.

FIG. 5 illustrates a flow diagram of an example system for vectorizing network data according to the system described in FIGS. 1-4 herein.

FIG. 6 illustrates a flow diagram of an example system for performing fine-granular RBAC in a RAG application of a network controller according to the techniques described in FIGS. 1-5.

FIG. 7 is a computer architecture diagram showing an illustrative computer hardware architecture for implementing a device that can be utilized to implement aspects of the various technologies presented herein.

### DESCRIPTION OF EXAMPLE EMBODIMENTS

### Overview

The present disclosure relates generally to the field of enterprise networking, and more particularly to enabling fine-granular RBAC for RAG applications in network controllers that minimize security risks and improve accuracy of responses.

A method to perform the techniques described herein may be implemented by a network controller. The method may include receiving, from a computing device, a user query including an identity token. The method may include generating, based on the user query, a first embedding. The method may also include receiving, from an authorization system, authorization data associated with the identity token. Additionally, the method may include sending, to a vector store, a search request comprising the first embedding and metadata associated with the authorization data, the metadata including resource group information. The method may include receiving, from the vector store, data associated with the first embedding. The method may also include generating, based on the data and the metadata, context data. The method may include sending, to a large language model (LLM), the context data and the user query. The method may include in response to receiving an output from the LLM, sending, to the computing device, the output for display via a user interface.

Another method to perform the techniques described herein may be implemented by a network controller. The method may include may receiving, from a domain database of the enterprise network, data associated with a domain service. The method may include generating, based on the data, vector embeddings representing the data. The method may include storing, in a vector store of the enterprise network, the vector embeddings. The method may also include determining key characteristics associated with a first vector embedding of the vector embeddings. The method may include determining resource group information associated with the key characteristics and storing, in the vector store and in association with the first vector embedding, metadata comprising the resource group information.

Additionally, any techniques described herein, may be performed by a system and/or device having non-transitory computer-readable media storing computer-executable instructions that, when executed by one or more processors, performs the method(s) described above and/or one or more non-transitory computer-readable media storing computer-readable instructions that, when executed by one or more processors, cause the one or more processors to perform the method(s) described herein.

### EXAMPLE EMBODIMENTS

Large Language Models (LLMs) may be utilized in enterprise ready system software such as Network Controllers and Network management software. RAG (Retrieval Augmented Generation) is an architectural pattern in LLM application world where it allows existing domain specific data to be leveraged by an LLM for variety of tasks such as summarization, extraction, reasoning, transformation, automation etc. For instance, with the introduction of transformer based LLMs, RAG has become an architectural pattern that is utilized to bring the power of GenAI to custom (personal, public and enterprise) data, that is not part of foundational model's training dataset.

In enterprise environments, network controllers play a crucial role in managing the security posture of network devices and applications. Large Language Models (LLMs) may be utilized in enterprise software such as network controllers and network management software. LLMs are generally trained using public data sets. RAG (Retrieval Augmented Generation) is an architectural pattern that enables private data (e.g., such as domain specific data) to be leveraged by an LLM for variety of tasks such as summarization, extraction, reasoning, transformation, automation etc. For instance, with the introduction of transformer based LLMs, RAG has become an architectural pattern that is utilized to bring the power of GenAI to custom (personal, public and enterprise) data, that is not part of foundational model's training dataset.

In enterprise networks, role-based access controls (RBACs) in network controllers and network management software may support typical RBACs, but also may extend RBACs to fine-granular network constructs such as Network Devices, Sites, Fabric, arbitrary groups of devices, etc. In standard NIST RBAC models, users may be assigned to one or more roles and roles depict a set of allowed permissions (permission set), where each permission represents RBAC resource type (to which access control is applied) and a set of allowed operations on that resource type. Thus, having a fine-granular RBAC over the network data and policies may be important for maintaining security within the enterprise network.

In some cases, network controllers and network management software of an enterprise network may leverage RAG in order to use private data (e.g., any data the LLM may not be aware of) as input to the LLM. For instance, RAG may be used to integrate LLMs with dynamic and static network data, inventory, configuration, policies etc. However, RAG enabled LLMs currently do not consider RBACs when retrieving vector embeddings or generating outputs to a user's query, resulting in security risks to the network.

As an example, RAG may be used to enable an LLM application, such as a chatbot user interface. In this approach, vector embeddings (e.g., a representation of a word, sentence, etc. in a way that the LLM can understand) are created for domain specific data first and stored in a vector database. When a user queries the LLM, such as through the chatbot user interface, a query agent may first search the vector store for embeddings matching user's question. The results may be re-ordered, filtered, re-ranked depending on the use case and domain data. Finally, the resulting embeddings are translated back to text and fed to LLM as context data along with user's original question. In this example, the LLM then tries to answer the question keeping the provided domain specific data as context.

However, when the embeddings are retrieved, the query agent is not aware of access control rules (e.g., RBACs) associated with the user providing the query. This is due to domain specific data being stored in an enterprise system's data store, along with associated RBAC context. Access to this domain specific data is usually controlled with enterprise RBAC rules authored on that system by administrators. However, with current RAG architecture, there is currently no mechanism to generate or store vector embeddings that include the RBAC context with specific domain data. Thus, the data retrieved from the vector store in response to a user's query (and subsequently input to the LLM) may include any information relevant to the user's query, regardless of whether they should have access to it or not. This results in violations of access control rules within the network and introduces various security risks. Further, by providing context to the LLM that may not be relevant to the particular user, the results displayed to the user may be less accurate.

Accordingly, there is a need for a mechanism to enable fine-granular RBAC for RAG applications in network controllers that minimize security risks and improve accuracy of responses in enterprise networks.

This disclosure describes techniques and mechanisms for a system to enable fine-granular RBACs for RAG applications in enterprise networks. In some examples, the system may be implemented by a network controller of an enterprise network. The system may perform operations including receiving, from a computing device, a user query including an identity token; generating, based on the user query, a first embedding; receiving, from an authorization system, authorization data associated with the identity token; sending, to a vector store, a search request comprising the first embedding and metadata associated with the authorization data, the metadata including resource group information; receiving, from the vector store, data associated with the first embedding; generating, based on the data and the metadata, context data; sending, to a large language model (LLM), the context data and the user query; and in response to receiving an output from the LLM, sending, to the computing device, the output for display via a user interface

This disclosure also describes techniques for vectorizing domain data for use in fine-granular RBAC in enterprise networks. The system may receive, from a domain database of the enterprise network, data associated with a domain service. The system may generate, based on the data, vector embeddings representing the data. The system may store, in a vector store of the enterprise network, the vector embeddings. The system may determine key characteristics associated with a first vector embedding of the vector embeddings. The system may determine resource group information associated with the key characteristics; and store, in the vector store and in association with the first vector embedding, metadata comprising the resource group information.

In some examples, the system may comprise a sync component. The sync component may be configured to access one or more domain database(s) within the enterprise system and retrieve domain data associated with one or more domain services (e.g., network inventory data or any other domain service data). The sync component may generate vector embeddings for the domain data and may store the vector embeddings in a vector store. The sync component may determine key characteristics (e.g., such as a network device and a configuration state of the network device) associated with each embedding. For each of the key characteristics, the sync component may identify RBAC information. For instance, the RBAC information may include resource group information, a site name associated with the network device, a fabric name associated with the network device, a device group name associated with the network device, etc.). The sync component may associate the RBAC information with the embedding in the vector store. For instance, the sync component may store the RBAC information as metadata associated with the embedding. For instance, the metadata may include RBAC information relevant to enforcing an access control rule for the particular key characteristic or embedding. Accordingly, the sync component may include metadata with the embedding that includes the RBAC rules that are being enforced (e.g., site, groups of devices, authorization, etc.) within the network. In some examples, the sync component may access and/or retrieve the domain data on a periodic basis or in a streaming manner. In some examples, the embeddings and associated metadata is not limited to a particular resource, site, etc.

In some examples, the system may comprise a retrieval augmentation generation (RAG) component. In some examples, RAG is an approach used to create augmented context. The augmented context may then be input into a model (e.g., such as a large language model (LLM) component or other machine learning mechanism) in order to provide outputs that are more customized and accurate. In some examples, the RAG component is implemented as a component of the network controller. In some examples, the RAG component may be implemented as part of a network management software. In some examples, the RAG component may include a query agent. The query agent may be configured to receive a user query and generate an embedding based on the user query. The query agent may be configured to extract an identity token associated with a user from the user query. In some examples, the query agent may communicate with an authorization system of the network. For instance, the query agent may request authorization data associated with the identity token. The authorization data may comprise role(s) associated with the identity token, resource group(s) associated with the identity token, and RBAC information (e.g., such as permission set(s) associated with a particular role and/or particular resource group). The query agent may generate and send a search request to the vector store, where the search request includes the embedding. In this example, the query agent may apply a metadata based RBAC filter to the data returned from the vector store search. For instance, the query agent may include a filtering component that uses the metadata based RBAC filter to match RBAC information associated with the identity token to the metadata in the embeddings returned from the vector store.

In some examples, the RAG component may generate a search request that includes the embedding and metadata that includes the RBAC information. For instance, the metadata may include RBAC information indicating metadata attributes to match during the search of the vector store. In this example, the vector store may be configured to support metadata queries. Accordingly, the embeddings within the vector store may be filtered during the search of the vector store, such that the embeddings returned from the vector store may be limited to embeddings associated with the user's query and that match the metadata filter(s).

In some examples, such as where the vector store utilizes a hierarchical based architecture, the RAG component may apply the metadata based RBAC filter before the search of the vector store is performed. In this example, the metadata based RBAC filter may be included in the search request, such that the search request limits the search of the vector store to a particular portion of the vector store. For instance, the search request may limit the search to the portion of the vector store associated with a particular site and/or particular permissions indicated by the metadata based RBAC filter.

In some examples, the RAG component may generate context data based on the data (e.g., embeddings) returned from the vector store and the user query. For instance, the RAG component may process vector store results further for re-ordering, re-ranking, and/or any other filtering based on resource group metadata. The RAG component may generate context data that includes transforming the processed embeddings into text. In some examples, the RAG component may generate and/or send the context data and the user's query to a LLM component of the network controller.

In some examples, the system may comprise a LLM component. In some examples, the LLM component may be implemented as an application or cloud application separate from the network controller. In some examples, the LLM component may be implemented as a component of the network controller or network management software. In some examples, the LLM component may be included as part of a private cloud or public cloud. For instance, the model component may comprise a machine learning model, such as an LLM, a small language model (SLM), or any other suitable technique. The model component may receive context data as input and may provide output associated with the user's query to the chatbot component.

In this way, the system may provide granular RBAC for LLM powered GenAI use-cases in enterprise networks. As noted above, existing techniques do not offer differentiated access to data (e.g., all users of the LLM receive the same results). In contrast to existing techniques, the system described herein may ensure that results are filtered and tailored based on the level of access the user has within the network, thereby removing the security risks introduced by RAG applications. Further, by enabling fine-granular RBAC, the system may provide outputs that are more accurate and customized to the particular user.

Certain implementations and embodiments of the disclosure will now be described more fully below with reference to the accompanying figures, in which various aspects are shown. However, the various aspects may be implemented in many different forms and should not be construed as limited to the implementations set forth herein. The disclosure encompasses variations of the embodiments, as described herein. Like numbers refer to like elements throughout.

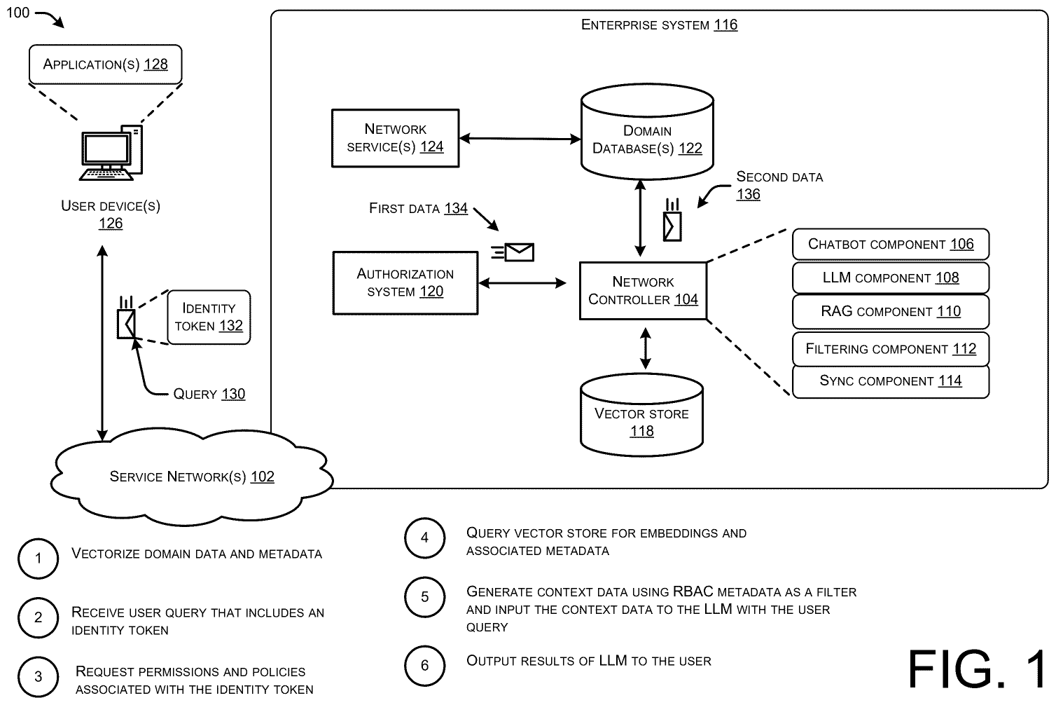

FIG. 1 illustrates a system-architecture diagram of an environment in which a system 100 can enable fine-granular RBAC in RAG applications of a network controller. As used herein, “fine-granular RBAC” refers to RBACs with control over individual resources and/or objects and/or group(s) of resources and/or objects. While the system 100 shows an example network controller 104, it is understood that any of the components of the system may be implemented on any device in the service network 102. Moreover, while the system 100 shows the example network controller 104 as being included as part of the service network 102, it is understood that the network controller 104 and/or any of the components of the system may be implemented as part of network management software. For instance, the network controller 104 may be included as part of a network service provided to a customer, such as Cisco's Catalyst Center. While the examples described herein may reference network controllers, it is understood that any network management software or network controller implementing an enterprise identity and/or RAG applications may utilize the techniques described herein.

In some examples, the system 100 may include a service network 102 that includes network devices. The service network 102 may include one or more networks implemented by any viable communication technology, such as wired and/or wireless modalities and/or technologies. The service network 102 may include any combination of Personal Area Networks (PANs), SDCI, Local Area Networks (LANs), Campus Arca Networks (CANs), Metropolitan Area Networks (MANs), extranets, intranets, the Internet, short-range wireless communication networks (e.g., ZigBee, Bluetooth, etc.), RA VPNs, VPNs, ZTNA, Wide Area Networks (WANs)—both centralized and/or distributed—and/or any combination, permutation, and/or aggregation thereof. The service network 102 may include devices, virtual resources, or other nodes that relay packets from one network segment to another by nodes in the computer network. The service network 102 may include multiple devices that utilize the network layer (and/or session layer, transport layer, etc.) in the OSI model for packet forwarding, and/or other layers. In some examples, the service network 102 comprises a cloud network and/or an enterprise network. In some examples, the network device(s) may comprise router(s), switch(es), server(s), or any other computing device.

The service network 102 may be implemented as part of an enterprise system 116 (e.g., company, school, or any other entity that may utilize role-based access control). As illustrated the enterprise system may include network service(s) 124, domain database(s) 122, authorization system 120, network controller 104, and vector store 118. In some examples, network service(s) 124 may comprise any domain service (e.g., such as network inventory service, event service, etc.) within the enterprise system 116. In some examples, the domain database(s) 122 may comprise domain data associated with one or more domain service(s) 124. In some examples, the domain database(s) 122 may correspond to a Mongo database or any other suitable database).

In some examples, the authorization system 120 may be configured to authenticate and authorize a user to access the service network 102 and/or enterprise system 116. For instance, the authorization system 120 may include an identity management component configured to authenticate credentials when a user logs into the service network 102 and/or enterprise system 116. In some examples, the authorization system 120 may utilize an OAuth standard, such that when the user's credentials are authenticated, the authorization system may send back an identity token 132 (e.g., such as a JWT token) to the user device 126, application 128, and/or may store the JWT token. In some examples, the authorization system 120 is configured to store access control rules (e.g., RBAC information, access control lists, resource role(s), and permission set(s) associated with particular user(s)) associated with the enterprise system 116 and/or the service network 102.

The vector store 118 may be configured to store vector embedding(s) and/or associated metadata. In some examples, the vector store 118 may be configured in a hierarchical architecture. In some examples, the vector store 118 may be configured to support metadata based search queries.

The network controller 104 may correspond to a system that has complete visibility into the fabric of a given network (e.g., enterprise network, smaller network, etc.). In some examples, the network controller 104 may comprise a network orchestrator, one or more processors, etc.

As illustrated the network controller 104 may comprise a chatbot component 106, LLM component 108, RAG component 110, filtering component 112, and sync component 114. The chatbot component 106 may be configured to interface with the user device 126 and/or application 128. For instance, the chatbot component 106 may be configured to receive a user query via a user interface and send the query to the RAG component. The chatbot component 106 may receive and display the output from the LLM component 108 via the user interface.

As described in greater detail below, the LLM component 108 is configured to receive context data and a user query as input and output a customized response. In some examples, the LLM component 108 may comprise a LLM that is trained using one or more public data sets (e.g., public domain data, foundation models, etc.).

As described in greater detail below, the RAG component 110 is configured to receive a user query from the chatbot component 106, generate an embedding based on the user query, communicate with the authorization system 120, generate and send a search request to the vector store 118, and generate and send context data and the user's query as input to the LLM component 108.

As described in greater detail below, the filtering component 112 is configured to perform post-search filtering of the embeddings and/or data returned from the vector store search. In some examples, the filtering component 112 is configured to apply the metadata based RBAC filter to the vector store prior to the search request. In some examples, the filtering component 112 may be included as part of the RAG component 110.

As described in greater detail below, the sync component 114 is configured to may be configured to access one or more domain database(s) within the enterprise system and retrieve domain data associated with one or more domain services (e.g., network inventory data or any other domain service data). The sync component may generate vector embeddings for the domain data and may store the vector embeddings in a vector store. The sync component 114 may also store RBAC information as metadata in association with the vector embeddings. In some examples, the sync component 114 may access and/or retrieve the domain data on a periodic basis or in a streaming manner. In some examples, the embeddings and associated metadata is not limited to a particular resource, site, etc.

The system 100 may include user device(s) 126. In some examples, user device(s) 126 may be configured to communicate with the enterprise system 116 via the service network(s) 102. In some examples, user device(s) 126 may correspond to any computing device capable of accessing the service network(s) 102. In some examples, user device(s) 126 may be associated with a user assigned to a particular role or resource group. The user device(s) 126 may comprise application(s) 128. Application(s) 128 may be configured to enable the user device(s) 126 to access service(s) of the service network 102. For instance, application(s) 128 may provide a dashboard, such as Cisco's Catalyst Center.

At “1”, the system may vectorize domain data and metadata. For instance, the system may access and/or retrieve second data 136 from domain database(s) 122, where the second data 136 comprises the domain data. In some examples, the system may generate vector embeddings using sync component 114. The system may identify and store the RBAC metadata as text within the vector embeddings. The system may store the vector embeddings in vector store 118.

At “2”, the system may receive a user query that includes an identity token. For instance, the user query 130 may comprise input into a chatbot user interface and may comprise a question or a request. The identity token may comprise identity token 132.

At “3”, the system may request permissions and policies associated with the identity token. For instance, the system may request first data 134 from the authorization system 120, such as by using RAG component 110. The first data 134 may comprise permissions associated with a role or resource group corresponding to the identity token, as well as access control policies and/or RBAC information.

At “4”, the system may query the vector store for embedding(s) and associated metadata. For instance, the system may generate a search query using the RAG component 110. The system may receive embeddings and associated metadata in response to the search query.

At “5”, the system may generate context data using a RBAC metadata as a filter and may input the context data to the LLM with user query. For instance, the system may apply a metadata based RBAC filter prior to sending the search request, as part of the search request, and/or after the search results are returned. The system may apply the metadata based RBAC filter in order to identify embeddings associated with the user query that the identity token is authorized to access. The system may generate the context data using RAG component 110. The system may filter the embeddings using RAG component 110 and/or filtering component 112. The system may input the context data and the user query to the LLM (e.g., such as LLM component 108).

At “6”, the system may output the results of the LLM to the user. For instance, the output of the LLM component may be sent to the RAG component 110. The RAG component may send the results to the chatbot component 106 for display via the user interface.

In this way, the system may provide granular RBAC for LLM powered GenAI use-cases in enterprise networks. As noted above, existing techniques do not offer differentiated access to data (e.g., all users of the LLM receive the same results). In contrast to existing techniques, the system described herein may ensure that results are filtered and tailored based on the level of access the user has within the network, thereby removing the security risks introduced by RAG applications. Further, by enabling fine-granular RBAC, the system may provide outputs that are more accurate and customized to the particular user.

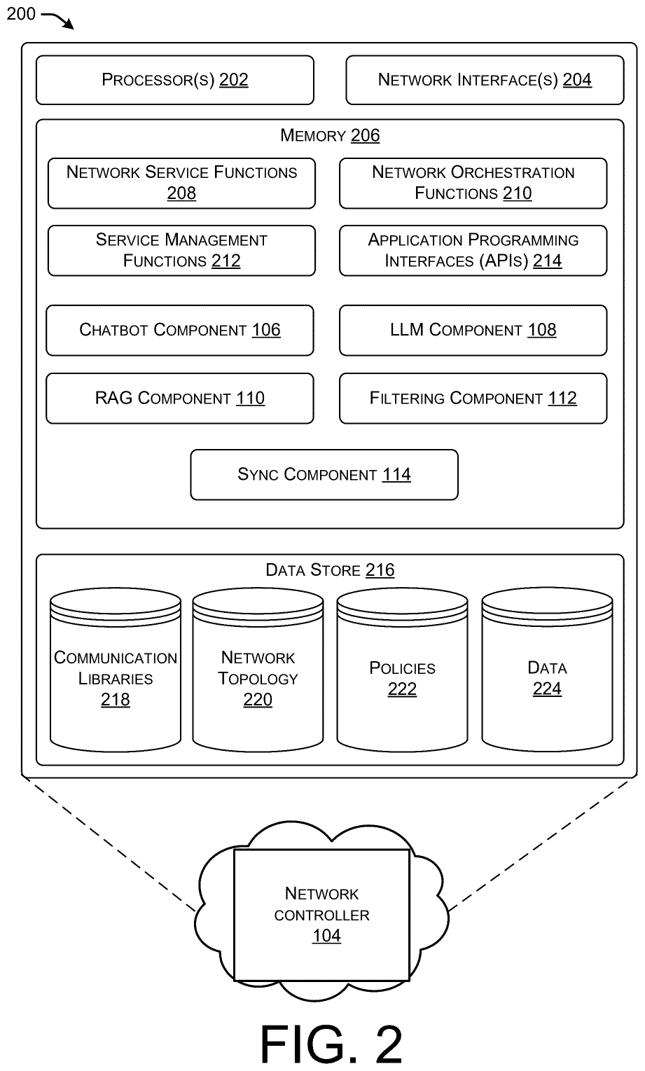

FIG. 2 illustrates a component diagram 200 of an example network controller, as described in FIG. 1. In some instances, one or more of the components of the network controller 104 may run on one or more computing devices in, or associated with, the service network 102 (e.g., a single device or a system of devices). In some instances, the network controller 104 may be integrated as part of an enterprise network.

Generally, the network controller 104 may include a programmable controller that manages some or all of the controller activities of the service network 102 and manages or monitors the network state using one or more centralized control models.

As illustrated, the network controller 104 may include, or run on, one or more hardware processors 202 (processors), one or more devices, configured to execute one or more stored instructions. The processor(s) 202 may comprise one or more cores. Further, the network controller 104 may include or be associated with (e.g., communicatively coupled to) one or more network interfaces 204 configured to provide communications with network device(s), the edge device(s), and other devices, and/or other systems or devices in the service network 102 and/or remote from the service network 102. The network interfaces 204 may include devices configured to couple to personal area networks (PANs), wired and wireless local area networks (LANs), wired and wireless wide area networks (WANs), SDCI's, and so forth. For example, the network interfaces 204 may include devices compatible with any networking protocol.

The network controller 104 may also include memory 206, such as computer-readable media, that stores various executable components (e.g., software-based components, firmware-based components, etc.). The memory 206 may generally store components to implement functionality described herein as being performed by the network controller 104. The memory 206 may store one or more network service functions 208, such as a slicing manager, a topology manager to manage a topology of the service network 102, a host tracker to track what network components are hosting which programs or software, a switch manager to manage switches of the service network 102, a process manager, and/or any other type of function performed by the network controller 104.

The network controller 104 may further include network orchestration functions 210 stored in memory 206 that perform various network functions, such as resource management, creating and managing network overlays, programmable APIs, provisioning or deploying applications, software, or code to hosts, and/or perform any other orchestration functions. Further, the memory 206 may store one or more service management functions 212 configured to manage the specific services of the service network 102 (configurable), and one or more APIs 214 for communicating with devices in the service network 102 and causing various controller functions to occur.

In some examples, the network controller 104 may include one or more of a chatbot component 106, a LLM component 108, a RAG component 110, a filtering component 112, and/or a sync component 114. In some examples, the network controller 104 may include additional or fewer components.

The chatbot component 106 may be configured to interface with the user device 126 and/or application 128. For instance, the chatbot component 106 may be configured to receive a user query via a user interface and send the query to the RAG component. The chatbot component 106 may receive and display the output from the LLM component 108 via the user interface

The LLM component 108 may be implemented as an application or cloud application separate from the network controller. In some examples, the LLM component may be implemented as a component of the network controller or network management software. In some examples, the LLM component may be included as part of a private cloud or public cloud. For instance, the model component may comprise a machine learning model, such as an LLM, a small language model (SLM), or any other suitable technique. The model component may receive context data as input and may provide output associated with the user's query to the RAG component 110 and/or the chatbot component 106.

The RAG component 110 may be configured to receive a user query and generate an embedding based on the user query. The RAG component may extract an identity token associated with a user from the user query. In some examples, the RAG component may communicate with an authorization system of the network. For instance, the RAG component may request authorization data associated with the identity token. The authorization data may comprise role(s) associated with the identity token, resource group(s) associated with the identity token, and RBAC information (e.g., such as permission set(s) associated with a particular role and/or particular resource group). The RAG component may generate and send a search request to the vector store, where the search request includes the embedding. In this example, the query agent may apply a metadata based RBAC filter to the data returned from the vector store search. For instance, the RAG component may include a filtering component (e.g., filtering component 112) that uses the metadata based RBAC filter to match RBAC information associated with the identity token to the metadata in the embeddings returned from the vector store.

In some examples, such as where the vector store utilizes a hierarchical based architecture, the RAG component may apply the metadata based RBAC filter before the search of the vector store is performed. In this example, the metadata based RBAC filter may be included in the search request, such that the search request limits the search of the vector store to a particular portion of the vector store. For instance, the search request may limit the search to the portion of the vector store associated with a particular site and/or particular permissions indicated by the metadata based RBAC filter.

In some examples, the RAG component may generate context data based on the data (e.g., embeddings) returned from the vector store and the user query. For instance, the RAG component may process vector store results further for re-ordering, re-ranking, and/or any other filtering based on resource group metadata. The RAG component may generate context data that includes transforming the processed embeddings into text. In some examples, the RAG component may generate and/or send the context data and the user's query to a LLM component of the network controller. While not illustrated, in some examples, the vector store 118 may be included as part of the network controller 104.

In some examples, the LLM component 108 and/or RAG component 110 may utilize one or more machine learning techniques to perform any of their respective functions. Machine learning techniques include, but are not limited to supervised learning algorithms (e.g., artificial neural networks, Bayesian statistics, support vector machines, decision trees, classifiers, k-nearest neighbor, etc.), unsupervised learning algorithms (e.g., artificial neural networks, association rule learning, hierarchical clustering, cluster analysis, etc.), semi-supervised learning algorithms, deep learning algorithms, etc.), statistical models, etc. As used herein, the terms “machine learning,” “machine-trained,” and their equivalents, may refer to a computing model that can be optimized to accurately recreate certain outputs based on certain inputs. In some examples, the machine learning models include deep learning models, such as convolutional neural networks (CNN), deep learning neural networks (DNN), and/or artificial intelligence models. The term “neural network,” and its equivalents, may refer to a model with multiple hidden layers, wherein the model receives an input (e.g., a vector) and transforms the input by performing operations via the hidden layers. An individual hidden layer may include multiple “neurons,” each of which may be disconnected from other neurons in the layer. An individual neuron within a particular layer may be connected to multiple (e.g., all) of the neurons in the previous layer. A neural network may further include at least one fully connected layer that receives a feature map output by the hidden layers and transforms the feature map into the output of the neural network. In some examples, the neural network comprises a graph where each node of the graph represents a layer within the neural network. Each node may be connected as part of a chain (e.g., a concatenation of layers). In some examples, input may be received by a node within the graph, the input is computed by the node and gets passed to one or more additional nodes in the chain.

The filtering component 112 may be configured to perform post-search filtering of the embeddings and/or data returned from the vector store search. In some examples, the filtering component 112 is configured to apply the metadata based RBAC filter to the vector store prior to the search request. In some examples, the filtering component 112 may be included as part of the RAG component 110.

The sync component 114 may be configured to access one or more domain database(s) within the enterprise system and retrieve domain data associated with one or more domain services (e.g., network inventory data or any other domain service data). The sync component may generate vector embeddings for the domain data and may store the vector embeddings in a vector store. The sync component may determine key characteristics (e.g., such as a network device and a configuration state of the network device) associated with each embedding. For each of the key characteristics, the sync component may identify RBAC information. For instance, the RBAC information may include resource group information, a site name associated with the network device, a fabric name associated with the network device, a device group name associated with the network device, etc.). The sync component may associate the RBAC information with the embedding in the vector store. For instance, the sync component may store the RBAC information as metadata associated with the embedding. For instance, the metadata may include RBAC information relevant to enforcing an access control rule for the particular key characteristic or embedding. Accordingly, the sync component may metadata with the embedding that includes the RBAC rules that are being enforced (e.g., site, groups of devices, authorization, etc.) within the network. In some examples, the sync component may access and/or retrieve the domain data on a periodic basis or in a streaming manner. In some examples, the embeddings and associated metadata is not limited to a particular resource, site, etc.

The network controller 104 may further include a data store 216, such as long-term storage, that stores communication libraries 218 for the different communication protocols that the network controller 104 is configured to use or perform. Additionally, the data store 216 may include network topology data 220, such as a model representing the layout of the network components in the service network 102 and/or data indicating available bandwidth, available CPU, delay between nodes, computing capacity, processor architecture, processor type(s), etc. The data store 216 may store policies 222 that include, but are not limited to, network policy(ies), network controller policy(ies), security data associated with the network, security policies configured for the network, firewall policies, firewall configuration data, network configuration policies, network configuration data, security posture data, and/or compliance policies configured for the network. The data store 216 may store data 224 including metadata, RBAC information, embeddings, identity tokens, performance data, traffic data, flow logs, instruction data, capability data associated with each network device, location data, telemetry data, or any other data and/or information described herein.

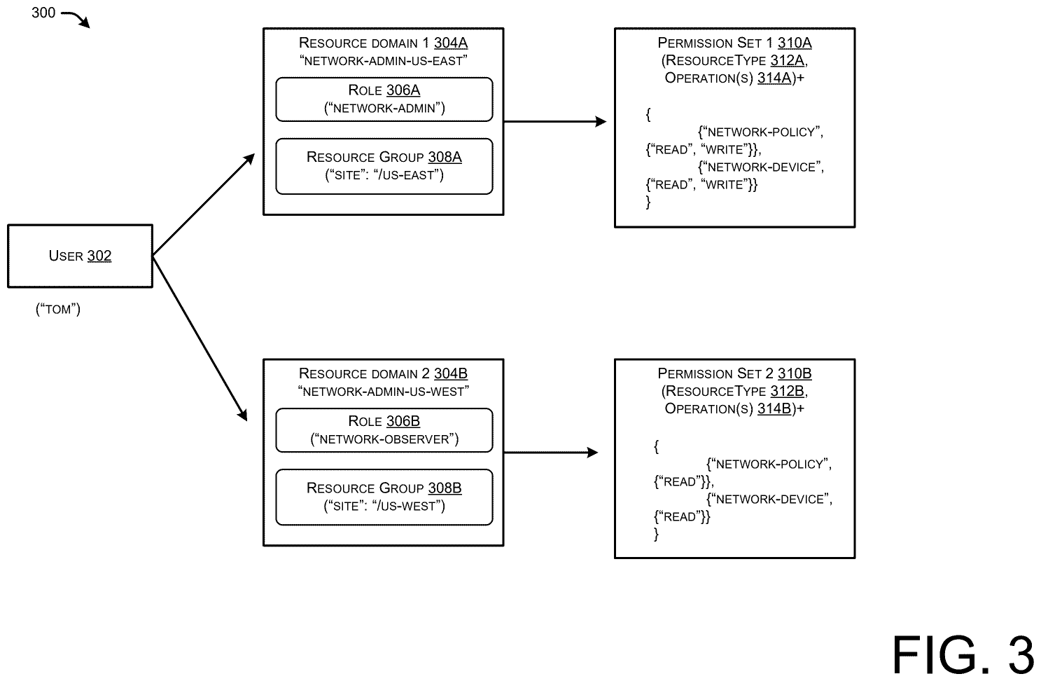

FIG. 3 illustrates an example embodiment 300 of fine-granular RBACs within an enterprise system, according to the techniques of FIGS. 1 and 2. In particular, the embodiment 300 described in FIG. 3 may relate to extending RBACs to include a fine-granular control that enables a user to define that a network administrator may access network device(s) and perform specific operation(s) for the network device(s) at a particular site within the enterprise network. That is, the fine-granular RBACs may enable the role of a user to be limited to a particular resource domain (e.g., resource group, site, etc.).

As illustrated, the embodiment 300 may include a user 302. In the illustrated example, the user may be defined as “Tom”. As illustrated the user 302 is assigned to resource domain 1 304A and resource domain 2 304B (referred to collective as resource domains 304). In some examples, each resource domain may comprise a combination of a role 306 and a resource group 308. For instance, the role 306 may comprise one or more of a network administrator, network observer, etc. A resource group 308 may comprise a group of resource instances, where a resource may correspond to a conceptual entity, such as a network device, a network site, or any other grouping that makes sense in a domain model.

In the illustrated embodiment, the user 302 is assigned to a resource domain 1 304A and resource domain 2 304B. In some examples, an enterprise system may enable a single resource domain to be active for the user at a time. As illustrated, resource domain 1 304A corresponds to “network-admin-us-east”. Role 306A may correspond to a network administrator role within a network and resource group 308A may comprise a site within the network, specifically “/us-east”).

As illustrated, resource domain 2 304B corresponds to “network-admin-us-west”. Role 306B may correspond to a network observer within a network and resource group 308B may comprise a site within the network, specifically “/us-west”).

The embodiment 300 may include permission sets. For instance, permission set 1 310A may be associated with role 304A. Permission set 1 310A may define what role 304A is allowed to do within the network. For instance, each permission in permission set 1 310A may represent a resource type and a set of allowed operations (e.g., list, read, write, delete, update, etc.) on that resource type. For example, resource types & allowed operations may include: network-inventory: {“list”, “read”, “write”}; network-device: {“read”, “write”, “delete”, “update”}; site-management: {“list”, “read”, “write”, “delete”, “update”}; etc.

In embodiment 300, resource type 312A may comprise a RBAC resource type that access control rules may be applied to. For instance, the resource type 312A may indicate a resource that the user 302 is authorized to access within the network. Operation(s) 314A may comprise indicate actions the user can perform with respect to the resource type. For instance, in permission set 1 310A, user 302 is permitted to “read” and “write” to resource type 312A). In the illustrated example, permission set 1 310B indicates that the user 302 is permitted to perform “read” and “write” operations on network policies and network device resource types, while in role 306A.

Further, permission set 1 310A may be associated with role 304A. Permission set 1 310A may define what role 304A is allowed to do within the network. For instance, permission set 2 310B includes resource type 312B and operation(s) 314B. In the illustrated example, permission set 2 310B indicates that the user 302 is permitted to perform “read” operations on network policies and network device resource types, while in role 306B. In some examples, the permission set(s) may be defined based on the role, domain, resource type, or any other characteristic of the user.

In this way, fine-granular RBAC may be applied to user(s) of an enterprise network, such that when a user logs into the enterprise system or requests access to a particular page of the network, a network controller may determine what information the user is authorized to access. As an example and not by way of limitation, a first user may request access to a network inventory page of an enterprise system. The system may determine, using an authorization system 120 and the fine-granular RBACs associated with an identity token of the first user, that the first user is associated with a role authorized to access network inventory data associated with a particular site (e.g., such as resource group 308A). In this example, the system may display network inventory data that is limited to network device(s) located at site “/us-east”. A second user may request access to the network inventory page. The system may determine, based on the second user's identity token that the second user is authorized to access network inventory data for network device(s) included in resource group 308B. Accordingly, the system may display network inventory data associated with the network device(s) at the second site (e.g., “/us-west”) to the second user. In some examples, the domain service (e.g., such as the network inventory service) of the enterprise network may perform the authorization of the user and filtering of data based on the fine-granular RBACs.

However, as described above, implementing fine-granular RBAC for RAG applications is difficult and results in the RBAC information and association being lost. For instance, in the previous example, the first user may submit a request to a chatbot asking to view network devices ranked by performance. Under existing techniques, the context data input into the LLM may include data for all network devices (e.g., network devices associated with resource group 308A and resource group 308B), such that the results displayed to the user includes data that (i) the user is not authorized to access and (ii) includes network device(s) not relevant to the user.

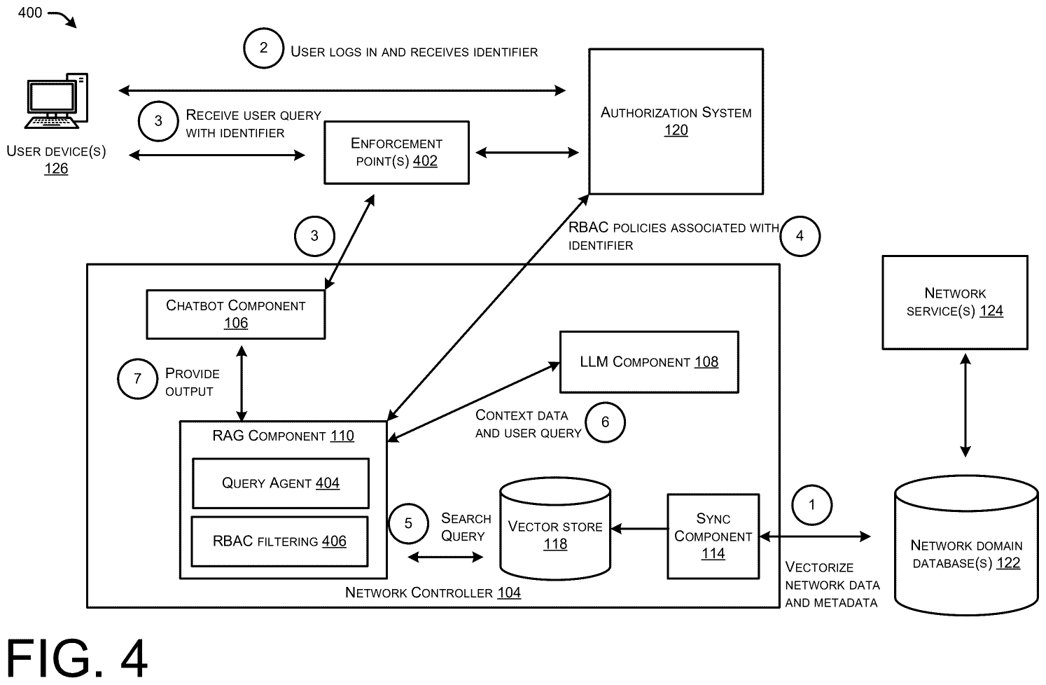

FIG. 4 illustrates an exemplary embodiment 400 of an architecture that may implement the fine-granular RBAC into RAG applications of a network controller in an enterprise system, according to the techniques of FIGS. 1-3. While the embodiment 400 described in FIG. 4 references a network inventory page, it is understood that the techniques described herein may apply to any enterprise system, domain service, or RAG application.

As illustrated in FIG. 4, the embodiment 400 includes user device(s) 126, authorization system 120, network controller 104, chatbot component 106, RAG component 110, LLM component 108, vector store 118, sync component 114, network domain database(s) 122 and network service(s) 124. As noted above, in some examples, the network service(s) 124 may include network domain service(s), one or more microservice(s) that manage a network domain service and/or domain data in the domain database(s) 122. In the illustrated embodiment 400, vector store 118 is included as part of the network controller 104. However, it is understood that the vector store 118 may be separate from the network controller 104.

Embodiment 400 further includes enforcement point(s) 402, query agent 404, and RBAC filtering 406. In some examples, enforcement point(s) 402 may represent a component of an enterprise system that ensures a user is authorized to access particular application(s), service(s), data, etc. prior to displaying information to the user. The enforcement point(s) 402 may validate an identity token of a user, apply authorization rules, perform policy enforcement, and may communicate with the authorization system 120 and/or network controller 104. In some examples, the enforcement point(s) 402 may utilize an API gateway or any other suitable techniques.

Query agent 404 may be implemented as part of the RAG component 110 and may be configured to perform one or more of the operations of the RAG component 110. RBAC filtering 406 may be implemented as part of the RAG component 110 and/or the query agent 404. In some examples, RBAC filtering 406 corresponds to the filtering component 112 described herein.

As noted above, embodiment 400 may correspond to an exemplary use case of integrating network inventory data with an LLM powered chatbot. For instance, a user may ask the chatbot any question about network inventory (e.g., network devices at a given site, enabled configuration(s), operational state(s), performance attribute(s), critical alert(s), etc.).

At “1,” the system may vectorize the network data and metadata. For instance, the sync component may access the network inventory data from the network domain database(s) 122. The sync component 114 may generate embeddings representing the network inventory data. The sync component 114 may associate metadata with the embeddings. For instance, the metadata may be included as text within the embeddings. The sync component 114 may store the embeddings within vector store 118.

As noted above, the vector store 118 may be organized according to a hierarchy. For instance, the hierarchy may be based on RBAC data, where embeddings are stored and/or grouped according to site(s), resource domain(s), resource group(s), or any other suitable hierarchy. Accordingly, embeddings associated with a particular site may be located in a particular portion of the vector store. In this example, where a search request identifies particular site(s), the system may limit a search of the vector store to the particular portion(s) associated with the particular site(s). Accordingly, utilizing a hierarchical structure may reduce computing resources utilized by the system by preventing a full search of the vector store.

At “2,” a user of the user device(s) 126 may log into an enterprise system and may receive an identifier. For instance, the user may send a login request to the authorization system to verify user credentials. Where the user credentials are verified, the authorization system may send an identifier (e.g., such as identity token 132) back to the user device(s) 126 for use in subsequent requests. The identifier may be associated with a particular user, access control rules, RBAC permissions, etc. of the user. In the above example, the user may log into a network inventory page of the enterprise system. The network inventory page may comprise an LLM powered chatbot.

At “3,” the enforcement point(s) 402 may receive a user query with the identifier. For instance, the user query may comprise an input to the chatbot. The enforcement point(s) 402 may verify, using the identifier and based on communicating with the authorization system 120, that the user may access data associated with the network inventory service page. The enforcement point(s) 402 may send the user query to the network controller 104. For instance, the chatbot component 106 may receive the user query and may forward the user query to the RAG component 110, along with the identifier. The query agent 404 may generate an embedding for the user query.

At “4,” the query agent 404 may retrieve RBAC policies associated with the identifier. For instance, the query agent 404 may extract the identifier from the user query. The query agent 404 may send the identifier to the authorization system 120 and request access control rules, policies, and RBAC information associated with the identifier. The query agent 404 may receive the access control rules, policies, and RBAC information from the authorization system 120. For example, the query agent may request the authorization system 120 to identify any role(s) associated with the identifier and allowed resource domain(s) (e.g., resource group(s)) associated with the identifier. In this example, the authorization system 120 may return data that indicates the user is allowed to see network inventory data associated with the “/us-east” site.

At “5,” the query agent 404 may generate and send a search query to the vector store 118. For instance, the search query may comprise the embedding associated with user's query, as well as data returned from the authorization system 120. In the above example, the search query may comprise a request for all vector embeddings relevant to the embedding of the user's query, under the filter of vector embeddings associated with the us-cast site. In this example, the search query instructs the vector store to apply the “us-east” site filter to the vector embeddings during the search of the vector store. Accordingly, the vector store 118 may return vector embeddings to the query agent 404 that comprise data that the user is authorized to access.

As noted above, in some examples, the search query may further identify a portion of the vector store 118 to search, such as where the vector store 118 is configured in a hierarchical manner. Moreover, in some examples, the search query may include additional filter(s) and/or RBAC information. For instance, the search query may comprise multiple metadata search filters to apply.

At “6,” the RAG component 110 may generate and send context data and the user query to the LLM component 108. For instance, the RAG component 110 may process the vector store search results (e.g., such as performing re-ordering, re-ranking, etc.) based on the RBAC information. For instance, in the above-described example, the vector store may return embeddings for the us-east site that are associated with the user's query. The RBAC filtering 406 may apply additional metadata filter(s) to the embeddings. For instance, the additional filters may include filtering the embeddings based on role(s) and/or permission set(s). The RAG component 110 may further re-order or re-rank the final embeddings based on characteristics of the embeddings, such as configuration(s) of the network device(s), ranking based on performance, etc. The RAG component may generate the context data by transforming the final embeddings into text. The context data and the user's query may be provided to the LLM component 108 as input. The LLM component 108 may provide an output using the context data and the user's query.

At “7,” the system may provide output to the user device(s) 126. For instance, the RAG component 110 may provide the output from the LLM component 108 to the chatbot component 106 and the chatbot component 106 may cause the output to be displayed via a user interface of the user device(s) 126.

Accordingly, unlike existing techniques, where RAG applications are provided context data that includes private data that the user may not be authorized to access, the techniques described herein improve network security by ensuring the LLM only receives context data that a user is authorized to access. Moreover, unlike existing techniques for LLMs, where users may receive the same results, by generating and storing RBAC information as metadata in association with the vector embeddings, the techniques described herein extend the use of fine-granular RBAC to RAG applications. That is, by enabling metadata based RBAC filtering to be performed before, during, and/or after searching the vector store, the techniques described herein may ensure that a user is provided with results that are filtered and tailored based on the level of access the user has within the network. Additionally, by ensuring that the LLM does not receive data the user is not authorized to view, the techniques described herein remove the security risks associated with existing RAG techniques, and providing improved accuracy of the LLMs.

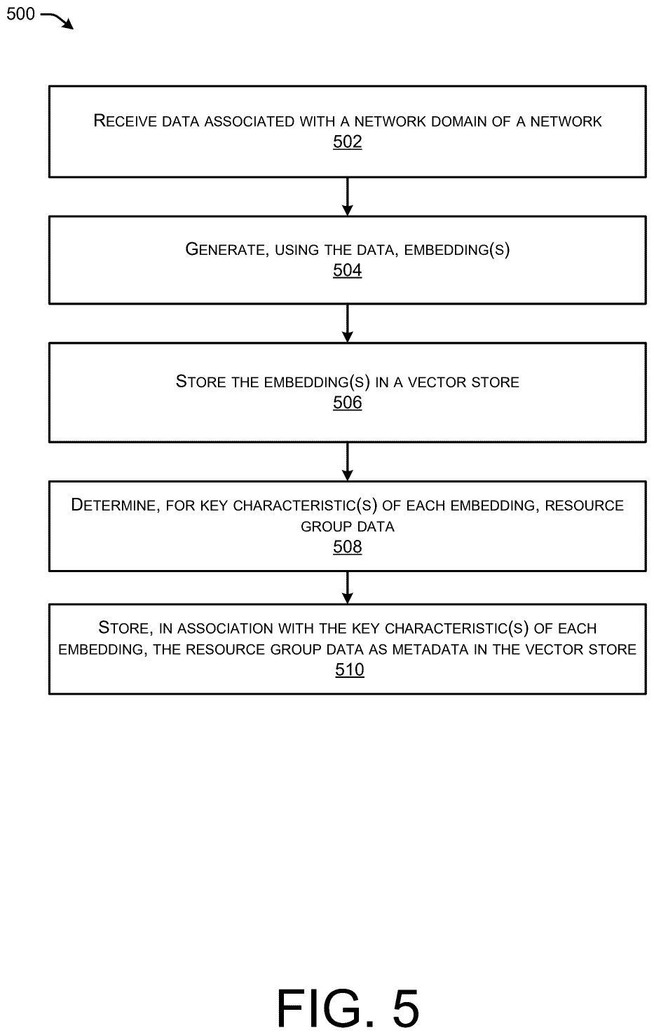

FIG. 5 illustrates a flow diagram of an example system 500 for vectorizing network data according to the system described in FIGS. 1-4 herein. The system 500 may be performed by one or more devices (e.g., network controller 104, etc.) that include one or more processors and one or more non-transitory computer-readable media storing computer-executable instructions that, when executed by the one or more processors, cause the one or more processors to perform operations of system 500.

At 502, the system may receive data associated with a network domain of a network. For instance, the system may periodically sync with one or more domain database(s) of the network. In some examples, the system may receive the data as part of a data stream.

At 504, the system may generate, using the data, embedding(s). In some examples, the embeddings comprise vector embeddings. The system may generate the embeddings using sync component 114.

At 506, the system may store the embedding(s) in a vector store. In some examples, the system may store the vector embeddings based on a hierarchy. For instance, the embeddings may be stored based on RBAC information or any other suitable grouping.

At 508, the system may determine, for key characteristic(s) of each embedding, resource group information. In some examples, the resource group information comprises role-based access control information including one or more of a resource domain, a resource group, a role, or a permission set. In some examples, the key characteristic(s) may correspond to a configuration state, an operational state, or other characteristic of a network device.

At 510, the system may store, in association with the key characteristic(s) of each embedding, the resource group data as metadata in the vector store. In some examples, the resource group information is stored as text in association with first vector embedding, and wherein the resource group information comprises rule-based access control rules being enforced and data associated with enforcing an authorization rule or access control policy. In some examples, the vector store is configured to support metadata-based search requests.

In this way, the system may generate and store vector embeddings for domain data of an enterprise network, along with metadata associated with the vector embeddings. For example, the vector embeddings may comprise network inventory data of network devices and the metadata may comprise site(s), resource group(s), authorization(s), etc. Accordingly, when a search of the vector store is performed, the vector embeddings may be searched using the metadata, such that the vector embeddings returned from the search correspond to data a user is authorized to access within the network.

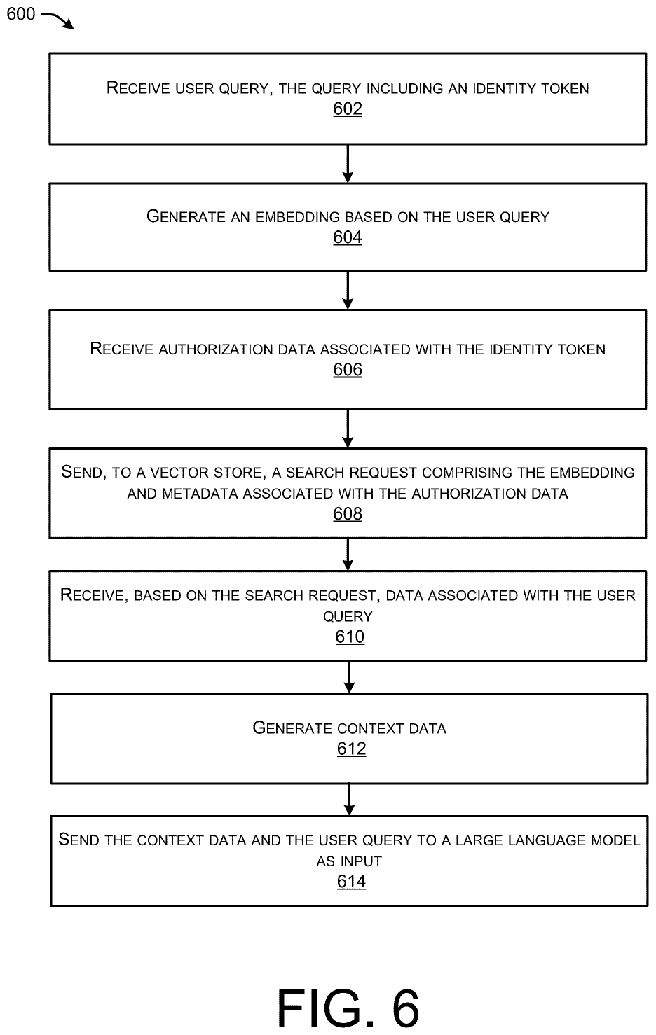

FIG. 6 illustrates a flow diagram of an example system 600 for performing fine-granular RBAC in a RAG application of a network controller according to the techniques described in FIGS. 1-5. In some instances, one or more of the steps of system 600 may be performed by one or more devices (e.g., network controller 104, etc.) that include one or more processors and one or more non-transitory computer-readable media storing computer-executable instructions that, when executed by the one or more processors, cause the one or more processors to perform operations of system 600.

At 602, the system may receive a user query, the user query including an identity token. For instance, the system may receive the user query from a computing device of the user. The user query may correspond to user input to a chatbot user interface or any other RAG application that may be utilized by an enterprise system.

At 604, the system may generate an embedding based on the user query. For instance, the system may generate the embedding using a RAG component and/or a query agent 404. In some examples, the system may extract the identity token from the user query.

At 606, the system may receive authorization data associated with the identity token. In some examples, the authorization data indicates types of data, devices, or resources the identity token is authorized to access within the network. For instance, the authorization data may be received from authorization system 120.

At 608, the system may send, to a vector store, a search request comprising the embedding and metadata. In some examples, the metadata comprises role-based access control information, including resource group name, site name, fabric name, and device group name. In some examples, the metadata is based on the authorization data.

At 610, the system may receive, based on the search request, data associated with the user query. For instance, the data may comprise vector embeddings associated with the user query, where the metadata is applied as a filter before, during, or after the search of the vector store. In some examples, the system may determine, prior to sending the search request, a portion of the vector store to search based on the user query and the identity token, wherein the search request indicates the portion of the vector store.

At 612, the system may generate context data. In some examples, generating the context data may include determining, based on filtering the data using the metadata, a subset of the data that the identity token is authorized to access within the network, wherein generating the context data is based on using the subset of the data.

At 614, the system may send the context data and the user query to a large language model as input.

In some examples, the system may generate, based on network inventory data, a plurality of embeddings. The system may store the plurality of embeddings in the vector store. The system may determine key characteristics associated with individual embeddings of the plurality of embeddings. The system may determine resource group metadata for each of the key characteristics. The system may store, in association with the key characteristics of the individual embeddings, the resource group metadata in the vector store. In some examples, the system may store the plurality of embeddings and the resource group metadata in the vector store based on a hierarchy.

In this way, the system may provide granular RBAC for RAG enabled LLMs in enterprise networks. As noted above, existing techniques do not offer differentiated access to data (e.g., all users of the LLM receive the same results). In contrast to existing techniques, the system described herein may ensure that results are filtered and tailored based on the level of access the user has within the network, thereby removing the security risks introduced by RAG applications. Further, by enabling fine-granular RBAC, the system may provide outputs that are more accurate and customized to the particular user.

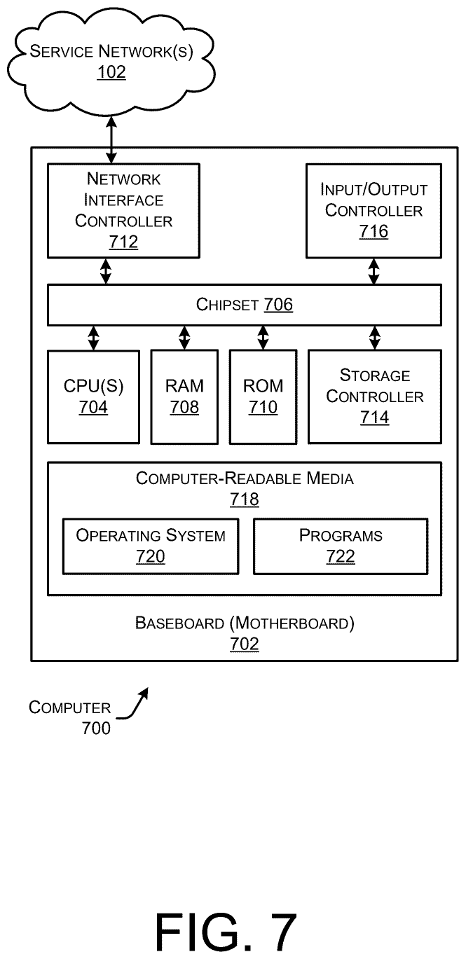

FIG. 7 shows an example computer architecture for a device capable of executing program components for implementing the functionality described above. The computer architecture shown in FIG. 7 illustrates any type of computer 700, such as a conventional server computer, workstation, desktop computer, laptop, tablet, network appliance, e-reader, smartphone, or other computing device, and can be utilized to execute any of the software components presented herein. The computer may, in some examples, correspond to a network controller 104 and/or any other device described herein, and may comprise personal devices (e.g., smartphones, tables, wearable devices, laptop devices, etc.) networked devices such as servers, switches, routers, hubs, bridges, gateways, modems, repeaters, access points, and/or any other type of computing device that may be running any type of software and/or virtualization technology.

The computer 700 includes a baseboard 702, or “motherboard,” which is a printed circuit board to which a multitude of components or devices can be connected by way of a system bus or other electrical communication paths. In one illustrative configuration, one or more central processing units (“CPUs”) 704 operate in conjunction with a chipset 706. The CPUs 704 can be standard programmable processors that perform arithmetic and logical operations necessary for the operation of the computer 700.

The CPUs 704 perform operations by transitioning from one discrete, physical state to the next through the manipulation of switching elements that differentiate between and change these states. Switching elements generally include electronic circuits that maintain one of two binary states, such as flip-flops, and electronic circuits that provide an output state based on the logical combination of the states of one or more other switching elements, such as logic gates. These basic switching elements can be combined to create more complex logic circuits, including registers, adders-subtractors, arithmetic logic units, floating-point units, and the like.

The chipset 706 provides an interface between the CPUs 704 and the remainder of the components and devices on the baseboard 702. The chipset 706 can provide an interface to a RAM 708, used as the main memory in the computer 700. The chipset 706 can further provide an interface to a computer-readable storage medium such as a read-only memory (“ROM”) 710 or non-volatile RAM (“NVRAM”) for storing basic routines that help to start up the computer 700 and to transfer information between the various components and devices. The ROM 710 or NVRAM can also store other software components necessary for the operation of the computer 700 in accordance with the configurations described herein.

The computer 700 can operate in a networked environment using logical connections to remote computing devices and computer systems through a network, such as service network 102. The chipset 706 can include functionality for providing network connectivity through a NIC 712, such as a gigabit Ethernet adapter. The NIC 712 is capable of connecting the computer 700 to other computing devices over the service network 102. It should be appreciated that multiple NICs 712 can be present in the computer 700, connecting the computer to other types of networks and remote computer systems.

The computer 700 can be connected to a storage device 718 that provides non-volatile storage for the computer. The storage device 718 can store an operating system 720, programs 722, and data, which have been described in greater detail herein. The storage device 718 can be connected to the computer 700 through a storage controller 714 connected to the chipset 706. The storage device 718 can consist of one or more physical storage units. The storage controller 714 can interface with the physical storage units through a serial attached SCSI (“SAS”) interface, a serial advanced technology attachment (“SATA”) interface, a fiber channel (“FC”) interface, or other type of interface for physically connecting and transferring data between computers and physical storage units.

The computer 700 can store data on the storage device 718 by transforming the physical state of the physical storage units to reflect the information being stored. The specific transformation of physical state can depend on various factors, in different embodiments of this description. Examples of such factors can include, but are not limited to, the technology used to implement the physical storage units, whether the storage device 718 is characterized as primary or secondary storage, and the like.

For example, the computer 700 can store information to the storage device 718 by issuing instructions through the storage controller 714 to alter the magnetic characteristics of a particular location within a magnetic disk drive unit, the reflective or refractive characteristics of a particular location in an optical storage unit, or the electrical characteristics of a particular capacitor, transistor, or other discrete component in a solid-state storage unit. Other transformations of physical media are possible without departing from the scope and spirit of the present description, with the foregoing examples provided only to facilitate this description. The computer 700 can further read information from the storage device 718 by detecting the physical states or characteristics of one or more particular locations within the physical storage units.

In addition to the mass storage device 718 described above, the computer 700 can have access to other computer-readable storage media to store and retrieve information, such as program modules, data structures, or other data. It should be appreciated by those skilled in the art that computer-readable storage media is any available media that provides for the non-transitory storage of data and that can be accessed by the computer 700. In some examples, the operations performed by the network controller 104 and/or any components included therein, may be supported by one or more devices similar to computer 700. Stated otherwise, some or all of the operations performed by the network controller 104 and/or any components included therein, may be performed by one or more computer devices.

By way of example, and not limitation, computer-readable storage media can include volatile and non-volatile, removable and non-removable media implemented in any method or technology. Computer-readable storage media includes, but is not limited to, RAM, ROM, erasable programmable ROM (“EPROM”), electrically-erasable programmable ROM (“EEPROM”), flash memory or other solid-state memory technology, compact disc ROM (“CD-ROM”), digital versatile disk (“DVD”), high definition DVD (“HD-DVD”), BLU-RAY, or other optical storage, magnetic cassettes, magnetic tape, magnetic disk storage or other magnetic storage devices, or any other medium that can be used to store the desired information in a non-transitory fashion.

As mentioned briefly above, the storage device 718 can store an operating system 720 utilized to control the operation of the computer 700. According to one embodiment, the operating system comprises the LINUX operating system. According to another embodiment, the operating system comprises the WINDOWS® SERVER operating system from MICROSOFT Corporation of Redmond, Washington. According to further embodiments, the operating system can comprise the UNIX operating system or one of its variants. It should be appreciated that other operating systems can also be utilized. The storage device 718 can store other system or application programs and data utilized by the computer 700.

In one embodiment, the storage device 718 or other computer-readable storage media is encoded with computer-executable instructions which, when loaded into the computer 700, transform the computer from a general-purpose computing system into a special-purpose computer capable of implementing the embodiments described herein. These computer-executable instructions transform the computer 700 by specifying how the CPUs 704 transition between states, as described above. According to one embodiment, the computer 700 has access to computer-readable storage media storing computer-executable instructions which, when executed by the computer 700, perform the various processes described above with regard to FIGS. 1-6. The computer 700 can also include computer-readable storage media having instructions stored thereupon for performing any of the other computer-implemented operations described herein.

The computer 700 can also include one or more input/output controllers 716 for receiving and processing input from a number of input devices, such as a keyboard, a mouse, a touchpad, a touch screen, an electronic stylus, or other type of input device. Similarly, an input/output controller 716 can provide output to a display, such as a computer monitor, a flat panel display, a digital projector, a printer, or other type of output device. It will be appreciated that the computer 700 might not include all of the components shown in FIG. 7, can include other components that are not explicitly shown in FIG. 7, or might utilize an architecture completely different than that shown in FIG. 7.

As described herein, the computer 700 may comprise one or more of a network controller 104 and/or any other device. The computer 700 may include one or more hardware processors (processors) configured to execute one or more stored instructions. The processor(s) may comprise one or more cores. Further, the computer 700 may include one or more network interfaces configured to provide communications between the computer 700 and other devices, such as the communications described herein as being performed by the network controller 104 and/or any other device. The network interfaces may include devices configured to couple to personal area networks (PANs), wired and wireless local area networks (LANs), wired and wireless wide area networks (WANs), and so forth. For example, the network interfaces may include devices compatible with Ethernet, Wi-Fi™, and so forth.

The programs 722 may comprise any type of programs or processes to perform the techniques described in this disclosure. For instance, the programs 722 may cause the computer 700 to perform techniques including receiving, from a computing device, a user query including an identity token; generating, based on the user query, a first embedding; receiving, from an authorization system, authorization data associated with the identity token; sending, to a vector store, a search request comprising the first embedding and metadata associated with the authorization data, the metadata including resource group information; receiving, from the vector store, data associated with the first embedding; generating, based on the data and the metadata, context data; sending, to a large language model (LLM), the context data and the user query; in response to receiving an output from the LLM, sending, to the computing device, the output for display via a user interface. The programs 722 may also cause the computer 700 to perform techniques including receiving, from a domain database of the enterprise network, data associated with a domain service; generating, based on the data, vector embeddings representing the data; storing, in a vector store of the enterprise network, the vector embeddings; determining key characteristics associated with a first vector embedding of the vector embeddings; determining resource group information associated with the key characteristics; and storing, in the vector store and in association with the first vector embedding, metadata comprising the resource group information.

In this way, the computer 700 can enable fine-granular RBAC to be applied to user(s) of an enterprise network, such that when a user logs into the enterprise system or requests access to a particular page of the network, a network controller may determine what information the user is authorized to access. As an example, and not by way of limitation, a first user may request access to a network inventory page of an enterprise system. The system may determine, using an authorization system 120 and the fine-granular RBACs associated with an identity token of the first user, that the first user is associated with a role authorized to access network inventory data associated with a particular site (e.g., such as resource group 308A). In this example, the system may display network inventory data that is limited to network device(s) located at site “/us-east”. A second user may request access to the network inventory page. The system may determine, based on the second user's identity token that the second user is authorized to access network inventory data for network device(s) included in resource group 308B. Accordingly, the system may display network inventory data associated with the network device(s) at the second site (e.g., “/us-west”) to the second user. In some examples, the domain service (e.g., such as the network inventory service) of the enterprise network may perform the authorization of the user and filtering of data based on the fine-granular RBACs. Moreover, the computer 700 may provide mechanisms for generating and storing vector embeddings for domain data of an enterprise network, along with metadata associated with the vector embeddings. For example, the vector embeddings may comprise network inventory data of network devices and the metadata may comprise site(s), resource group(s), authorization(s), etc. Accordingly, when a search of the vector store is performed, the vector embeddings may be searched using the metadata, such that the vector embeddings returned from the search correspond to data a user is authorized to access within the network.

While the invention is described with respect to the specific examples, it is to be understood that the scope of the invention is not limited to these specific examples. Since other modifications and changes varied to fit particular operating requirements and environments will be apparent to those skilled in the art, the invention is not considered limited to the example chosen for purposes of disclosure, and covers all changes and modifications which do not constitute departures from the true spirit and scope of this invention.

Although the application describes embodiments having specific structural features and/or methodological acts, it is to be understood that the claims are not necessarily limited to the specific features or acts described. Rather, the specific features and acts are merely illustrative some embodiments that fall within the scope of the claims of the application.

What is claimed is:

1. A method implemented by a network controller of an enterprise network, the method comprising:
receiving, from a computing device, a user query including an identity token;
generating, based on the user query, a first embedding;
receiving, from an authorization system, authorization data associated with the identity token;
sending, to a vector store, a search request comprising the first embedding and metadata associated with the authorization data, the metadata including resource group information;
receiving, from the vector store, data associated with the first embedding;
generating, based on the data and the metadata, context data;
sending, to a large language model (LLM), the context data and the user query; and
in response to receiving an output from the LLM, sending, to the computing device, the output for display via a user interface.

2. The method of claim 1, further comprising:
generating, based on network inventory data, a plurality of embeddings;
storing the plurality of embeddings in the vector store;
determining key characteristics associated with individual embeddings of the plurality of embeddings;
determining resource group metadata for each of the key characteristics; and
storing, in association with the key characteristics of the individual embeddings, the resource group metadata in the vector store.

3. The method of claim 2, wherein the plurality of embeddings and the metadata is stored in the vector store based on a hierarchy.

4. The method of claim 1, wherein the metadata comprises role-based access control information, including resource group name, site name, fabric name, and device group name.

5. The method of claim 1, wherein the authorization data indicates types of data, devices, or resources the identity token is authorized to access within the enterprise network.

6. The method of claim 1, wherein generating the context data further comprises:
determining, based on filtering the data using the metadata, a subset of the data that the identity token is authorized to access within the enterprise network,
wherein generating the context data is based on using the subset of the data.

7. The method of claim 1, further comprising:
determining, prior to sending the search request, a portion of the vector store to search based on the user query and the identity token,
wherein the search request indicates the portion of the vector store.

8. The method of claim 1, wherein the vector store is configured to support metadata search requests.

9. The method of claim 1, wherein the enterprise network utilizes retrieval augmented generation based LLMs.

10. A system comprising:
one or more processors; and
one or more computer-readable media storing instructions that, when executed by the one or more processors, cause the one or more processors to perform operations comprising:
receiving, from a computing device, a user query including an identity token;
generating, based on the user query, a first embedding;
receiving, from an authorization system, authorization data associated with the identity token;
sending, to a vector store, a search request comprising the first embedding and metadata associated with the authorization data, the metadata including resource group information;
receiving, from the vector store, data associated with the first embedding;
generating, based on the data and the metadata, context data;
sending, to a large language model (LLM), the context data and the user query; and
in response to receiving an output from the LLM, sending, to the computing device, the output for display via a user interface.

11. The system of claim 10, the operations further comprising:
generating, based on network inventory data, a plurality of embeddings;
storing the plurality of embeddings in the vector store;
determining key characteristics associated with individual embeddings of the plurality of embeddings;
determining resource group metadata for each of the key characteristics; and
storing, in association with the key characteristics of the individual embeddings, the resource group metadata in the vector store.

12. The system of claim 10, wherein the metadata comprises role-based access control information, including resource group name, site name, fabric name, and device group name.

13. The system of claim 10, wherein the authorization data indicates types of data, devices, or resources the identity token is authorized to access within a network.

14. The system of claim 10, wherein generating the context data further comprises:
determining, based on filtering the data using the metadata, a subset of the data that the identity token is authorized to access within a network,
wherein generating the context data is based on using the subset of the data.

15. The system of claim 10, the operations further comprising:
determining, prior to sending the search request, a portion of the vector store to search based on the user query and the identity token,
wherein the search request indicates the portion of the vector store.

16. The system of claim 10, wherein the vector store is configured to support metadata search requests.

17. The system of claim 10, wherein the system is implemented by an enterprise network utilizes retrieval augmented generation based LLMs.

18. A method implemented by a network controller of an enterprise network, the method comprising:
receiving, from a domain database of the enterprise network, data associated with a domain service;
generating, based on the data, vector embeddings representing the data;
storing, in a vector store of the enterprise network, the vector embeddings;
determining key characteristics associated with a first vector embedding of the vector embeddings;
determining resource group information associated with the key characteristics; and
storing, in the vector store and in association with the first vector embedding, metadata comprising the resource group information.

19. The method of claim 18, wherein the resource group information is stored as text in association with the first vector embedding, and wherein the resource group information comprises rule-based access control rules being enforced and data associated with enforcing an authorization rule or access control policy.

20. The method of claim 18, wherein storing the vector embeddings is based on a hierarchy.
